(19) United States
(12) Patent Application Publication
(10) Pub. No.: US 2018/0042806 A1
(43) Pub. Date: Feb. 15, 2018

(54) Muscle Roller

(71) Applicant: Nicholas Thomas West, Chicago, IL (US)

(72) Inventor: Nicholas Thomas West, Chicago, IL (US)

(21) Appl. No.: 15/232,043

(22) Filed: Aug. 9, 2016

(51) Int. Cl. A61H 15/00

(52) U.S. Cl. CPC A61H 15/0092; A61H 2015/0021; A61H 2201/0107; A61H 2201/0157

(57) ABSTRACT

The present invention is a muscle roller. It has interchangeable foam rollers connected to an alternate hand grip which is connected to a removable hand grip. The rollers are interchangeable with different levels of firmness. The tension of the roller is adjustable to meet the preference of the user of the roller. In the preferred embodiment, the muscle roller body can fit into a regular backpack, gym bag or even in a carrying bag.

### CROSS-REFERENCES TO RELATED APPLICATIONS (IF ANY)

None

### BACKGROUND

### 1. Field of the Invention

The invention relates to a massage device in particular foam muscle rollers.

### 2. Description of Prior Art

There is a variety of tools and devices people can use to message their aches and pains in their muscles. Items vary from prescribed painkillers and over the counter medications to electric stimulants and wooden rollers to message the muscle. These products are in demand as the population ages.

The history of the products and industry go back a fairly substantial time period. Back in the 1970's and 1980's wooden roller seat cushions were popular with taxi drivers and others who sat for long period of time. From there the wooden roller developed into a line mechanism that could be rolled against a person's back to message it. Today there a wide array of messaging devices for sore and aching muscles. There are shower sprays, which help to message the body while cleaning up. There are electric stimulating devices that send an electrical current through the person muscles helping it to relax. There are portable heating devices, which slowly permeate the muscle with heat to relax the muscle. Then there are electrical rollers, which message the muscles to aid in the comfort of the sore muscles.

There is still room for improvement in the art.

### SUMMARY OF THE INVENTION

The present invention is a muscle roller. It has interchangeable foam rollers connected to an alternate hand grip which is connected to a removable hand grip. The rollers are interchangeable with different levels of firmness. The tension of the roller is adjustable to meet the preference of the user of the roller. In the preferred embodiment, the muscle roller body can fit into a regular backpack, gym bag or even in a carrying bag.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows the current invention and its main components; and

FIG. 2 shows a dual roller configuration.

### DESCRIPTION OF THE PREFERRED EMBODIMENT

There are a number of significant design features and improvements incorporated within the invention.

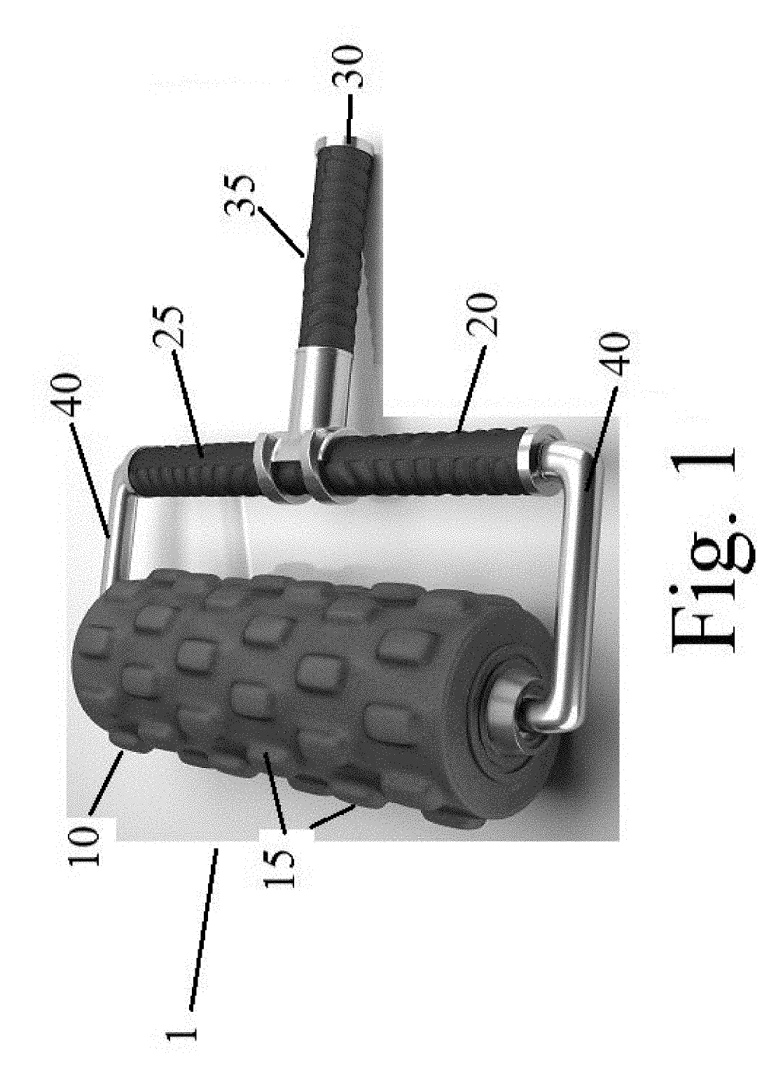

The present invention is a muscle roller device 1 as shown in FIG. 1.

It has interchangeable foam rollers 10 connected to an alternate hand grip 20 which is connected to a removable hand grip 30. The rollers 10 are interchangeable with different levels of firmness.

The tension of the roller device 10 is adjustable to meet the preference of the user of the muscle roller device 1. In the preferred embodiment, the muscle roller device 1 can fit into a regular backpack, gym bag or even in a carrying bag.

The foam rollers 10 are in a cylinder shape with a axis opening in the center. The roller 10 has a cylindrical core 16 with a foam covering 12 secured to the cylindrical core 16. The foam covering 12 have nubs 15 spaced evenly on the outside surface. These nubs 15 are rounded rectangular in shape and extend out from the surface of the roller 10. The nubs 15 are made of foam with the foam hardness adjusted for the user. They run parallel with the roller 15. They are designed to help the massaging of a person's muscles as they roll over them. It allows for a deeper massage. The foam covering 12 may or may not be permanently attached to the cylindrical core 16. The foam covering 12 are offered in different hardness or softness to match the users needs.

The muscle roller device 1 had a roller frame 40 which connects to the alternate hand grip 20 and angles out 90 degrees from the alternate hand grip 20 and connects to the roller 10. The roller frame serves as an axis for the roller 10 and roller 10 turns about the roller frame 40. The roller frame 40 will be made of a strong sturdy material like aluminum or a hard plastic. The tension that the roller 10 rotates on the roller frame 40 is adjustable to fit the needs and wants of the user.

The muscle roller device 1 has an alternate hand grip 20 which is perpendicular to the roller 10 which provides a hand hold for the user to use. It will have a handle cover 25 made of a soft grip able material like rubber.

The muscle roller device 1 will also have a removable hand grip 30 that attaches to the alternate hand grip 20 through and attachment means 50 like a clip. In the preferred embodiment it is perpendicular to the alternate hand grip 20 and extends out from the middle of the alternate hand grip 20. It has a grip 30 made of a soft grip able material so that the user can have a secure grip on the device 1.

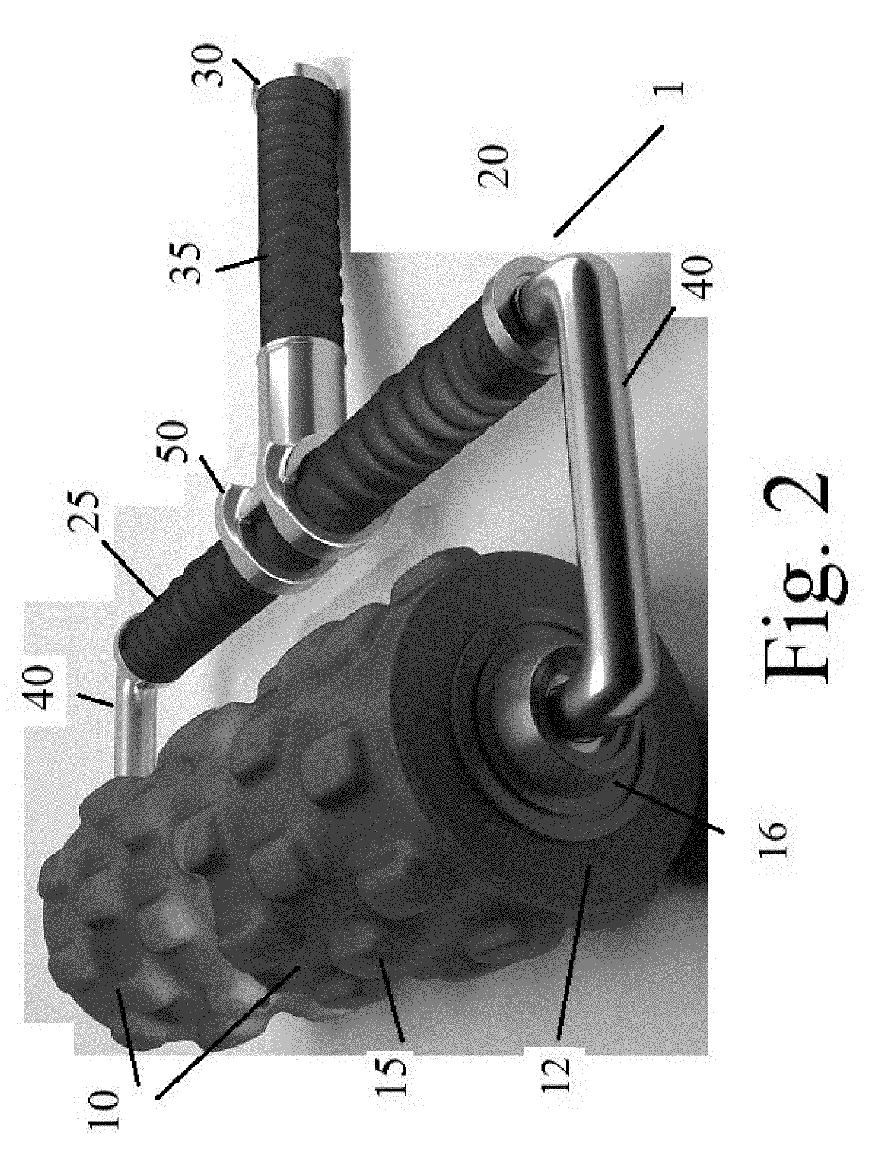

As shown in FIG. 2, more than one roller 10 can be used. It this configuration two rollers are used. The muscle roller device's roller frame 40 is adjustable to be used with rollers 10 of different length or multiple rollers 10.

A user holds the device 1 either with the removable hand grip 30 or the alternate hand grip 20 and places the roller 10 on the person at area of the body that needs massaged. The user will then roll to roller 10 on that person's body to provide the proper massage.

The ultimate muscle roller allows someone to massage the pain away in any of their muscles. The design is unique and unlike any other roller you've encountered made from the best materials, we know you're going to enjoy. Easy to carry, light weight design. interchangeable lengths′, Foam material messages your muscles It is great for after a workout or stress release.

### Advantages

The current invention is great for after a workout or stress release. Its smaller foam roller body device can be use to reach areas easier than contorting your body to reach those areas with traditional foam rollers. It looks similar to a paint roller so that it can be used with one hand.

Easy to carry, light weight design. interchangeable lengths′, Foam material massages a person's muscles. It is great for after a workout or stress release.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A massage device comprising:
a foam roller connected to a hand grip by a frame.

2. The massage device as recited in claim 1, further comprising:
where the rollers are interchangeable with different levels of firmness.

3. The massage device as recited in claim 1, further comprising:
where the rollers have a foam layer attached to a cylindrical core.

4. The massage device as recited in claim 1, further comprising:
where the rollers have nubs on their surface.

5. The massage device as recited in claim 4, further comprising:
where the nubs are rectangular in shape and are parallel to the roller.

6. The massage device as recited in claim 4, further comprising:
where the nubs are shaped evenly on the surface of the roller.

7. The massage device as recited in claim 3, further comprising:
where the foam covering removable from the cylindrical core.

8. The massage device as recited in claim 1, further comprising:
where the tension that the roller rotates on the frame is adjustable.

9. The massage device as recited in claim 1, further comprising:
where the grip has a removable hand grip attached to it.

10. The massage device as recited in claim 9, further comprising:
where the removable hand grip attached to the grip at a 90 degree angle.

11. The massage device as recited in claim 1, further comprising:
where a plurality of rollers can be used.

12. A massage device comprising:
foam rollers where the rollers have a foam layer attached to a cylindrical core and connected to a hand grip by a frame where the rollers have nubs on their surface.

13. The massage device as recited in claim 12, further comprising:
where the rollers are interchangeable with different levels of firmness.

14. The massage device as recited in claim 12, further comprising:
where the nubs are rectangular in shape and are parallel to the roller and are shaped evenly on the surface of the roller.

15. The massage device as recited in claim 12, further comprising:
where the foam covering removable from the cylindrical core.

16. The massage device as recited in claim 12, further comprising:
where the tension that the roller rotates on the frame is adjustable.

17. The massage device as recited in claim 12, further comprising:
where the grip has a removable hand grip attached to it.

18. The massage device as recited in claim 17, further comprising:
where the removable hand grip attached to the grip at a 90 degree angle.

19. The massage device as recited in claim 12, further comprising:
where a plurality of rollers can be used.

20. A process of giving a massage using the device in claim 12.
